(19) United States
(12) Patent Application Publication
(10) Pub. No.: US 2011/0133920 A1
(43) Pub. Date: Jun. 9, 2011

(54) Method & Apparatus for Improving Fuel Efficiency of Mass-Transit Vehicles

(76) Inventor: Ives B. MEADORS, Portland, OR (US)

(21) Appl. No.: 13/024,329

(22) Filed: Feb. 10, 2011

Related U.S. Application Data
(60) Provisional application No. 61/313,548, filed on Mar. 12, 2010.

(51) Int. Cl. G06F 7/00; B60Q 1/00

(52) U.S. Cl. 340/439; 701/36

(57) ABSTRACT

Vehicles (and particularly mass-transit vehicles) that are powered by internal-combustion engines can realize fuel savings and reduce greenhouse gas and waste heat emissions by moving some of the load of generating electricity for the vehicle's systems to different times in the vehicle's operation. During periods of heavy engine load (e.g., acceleration and hill-climbing) electrical generation may be reduced. During periods of light load, braking, hill-descending and other conversions of kinetic energy to heat, electrical generation may be increased.

### PRIORITY CLAIM

This application claims the benefit of U.S. Provisional Application No. 61/313,548, filed Mar. 12, 2010.

### FIELD

The invention relates to systems for improving the fuel efficiency of internal-combustion vehicles. More specifically, the invention relates to systems and methods for altering the normal operation of mass-transit vehicles such as buses to recover and re-use energy that would otherwise be wasted.

### BACKGROUND

Many cities, municipalities and other entities operate mass transit systems for the benefit of their citizens, employees or guests. Such systems (which may include trains, subways, buses, boats and/or aircraft) can provide economical transportation for riders (on a cost per person-kilometer basis), but they also represent significant infrastructure, capital, maintenance and operational costs for their owners.

Rising fuel costs and other environmental factors make replacement of older, less-efficient vehicles desirable, but financial considerations often prevent fleet owners from upgrading vehicles as quickly as they would like. Retrofit systems that can improve fuel efficiency and reduce emissions of older vehicles may be attractive as a lower-cost, interim measure until full replacement becomes feasible.

### SUMMARY

The invention improves internal-combustion vehicle fuel efficiency by altering the times when electricity to meet vehicle needs is generated. The system can be installed easily as a retrofit on existing vehicles, and requires no special care or maintenance. In addition to the improved fuel efficiency (and corresponding reduction in greenhouse-gas emissions), the invention manages vehicle batteries with greater care, resulting in lower likelihood of battery failure, less-frequent replacements, and fewer jump-start service calls.

### BRIEF DESCRIPTION OF DRAWINGS

Embodiments of the invention are illustrated by way of example and not by way of limitation in the figures of the accompanying drawings in which like references indicate similar elements. It should be noted that references to “an embodiment” or “one embodiment” in this disclosure are not necessarily to the same embodiment, and such references mean “at least one.”

FIG. 1 shows a block diagram of an embodiment of the invention augmenting a legacy internal-combustion-vehicle system.

FIG. 2 is a block diagram of some of the systems of a prior-art vehicle that affect or are affected by an embodiment of the invention.

FIG. 3 (in two parts) is a flow chart outlining operations of an embodiment of the invention.

FIG. 4 shows a simplified circuit of some portions of an embodiment.

FIGS. 5A-5D show how an embodiment of the invention can accomplish bidirectional power transfer.

FIGS. 6 and 7 show two additional embodiments of the invention.

### DETAILED DESCRIPTION

Embodiments of the invention recover some kinetic energy that would otherwise be wasted in the normal operation of a mass-transit vehicle. The energy may be stored temporarily in an auxiliary battery pack or capacitor-based device, then it is fed back to the vehicle through its own charging system to alter the load placed on the main power plant by the vehicle's generator. It is appreciated that, generally speaking, neither the average load nor accumulated total energy devoted to electricity generation can be significantly altered as the vehicle travels over any particular route, but by changing the time (or conditions) when the electricity is generated, a substantial fuel savings can be realized.

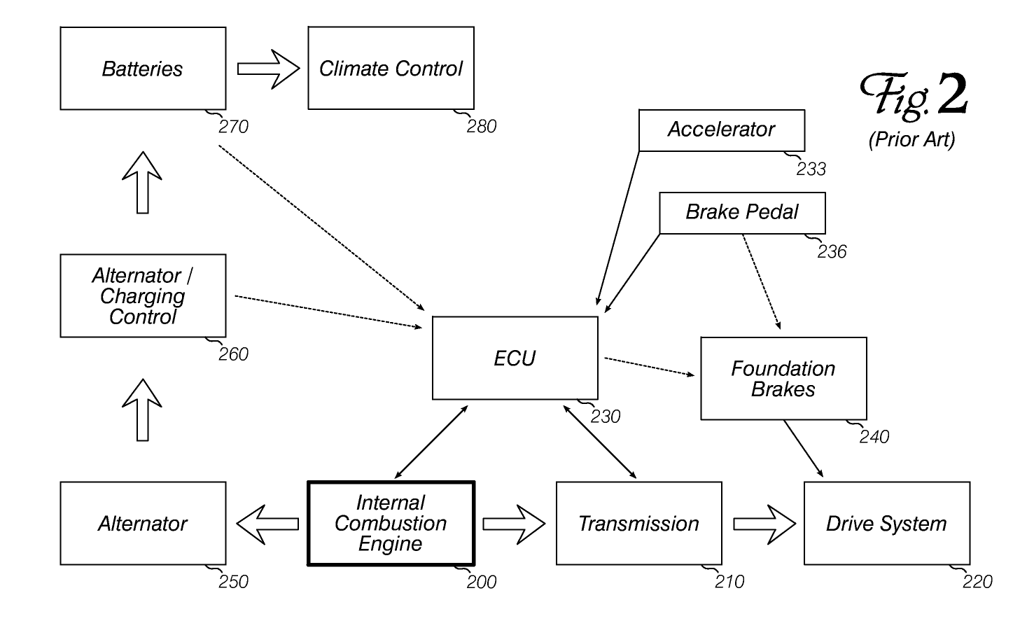

FIG. 2 shows a block diagram of some subsystems of a contemporary mass-transit vehicle. In general, all power used by the vehicle is produced by an internal-combustion engine (“ICE”) 200. Most of the power produced is directed through a transmission 210 to a drive system 220 which ultimately causes the wheels to go round and round. An engine control unit or “ECU” 230 receives inputs such as operator controls accelerator (“gas pedal”) 233 and brake pedal 236, as well as information from other sources, and causes ICE 200 and transmission 210 to operate appropriately. Most current-technology vehicles are “drive-by-wire,” so there is no mechanical linkage between controls such as accelerator 233 or brake 236, and the engine or other parts of the drive system. Instead, an electronic data communication channel such as a J1939 bus carries information about the vehicle's operational status and the state of various control inputs from one part of the vehicle to another, to cause other parts to perform their desired functions. For example, a position sensor may report over the data bus that the driver has pressed the gas pedal clown, and the ECU may respond to the report by providing more fuel and air to the engine, which in turn causes the engine to produce more power and (possibly) causes the vehicle to accelerate. The J1939 data bus is described in specifications from the Society of Automotive Engineers (“SAE”) but embodiments of the invention can operate with other drive-by-wire data distribution systems, as well as in vehicles that use older, all-mechanical control mechanisms.

Returning to FIG. 2, note that in this drive-by-wire vehicle, brake pedal 236 may cause ECU 230 to slow the vehicle by reducing ICE power or adjusting transmission 210 to operate in a less-efficient mode (possibly overdriving ICE 200 to produce an “engine braking” effect). The vehicle's friction brakes (“foundation brakes”) 240 may be used mostly for final stopping and/or holding position. This method of operation reduces wear on friction brakes, but causes the vehicle's excess kinetic energy to be converted to heat in the engine and transmission (in fact, the cooling systems and fans to dissipate this heat are a significant consumer of overall vehicle power production).

Some power from ICE 200 is coupled to an alternator 250, which converts mechanical (often rotary) motion to electricity that is delivered to an alternator /charging control system 260 and used to charge batteries 270, and/or to power electrical loads such as climate-control system 280 directly. Many mass-transit vehicles use a 24-volt (nominal) electrical system, rather than the 12-volt (nominal) system commonly used by passenger vehicles. However, support for 12-volt accessories may also be desired in a 24-volt vehicle, so a DC/DC converter or 12-volt auxiliary battery and charging system (not shown) may be present also.

Mass transit vehicles may devote a surprisingly large portion of the ICE's power to operating electrical systems: air conditioners, heaters, lighting, hydraulic lifts and other accessories (to say nothing of engine cooling fans and hydraulic transmission actuators) consume a significant amount of power. A typical mass-transit bus might be fitted with a with a 15 kW output alternator which may require 27 horsepower (“HP”) input, driven by a typical engine of 280 HP (208 kW), but a straightforward comparison of the relative peak capacities of the engine and alternator does not tell the whole story—the alternator is more likely to be operated at higher outputs, and for longer periods, than the engine. Over a period of hours or clays, it would not be unusual to find that considerably more than 10% of the total mechanical energy produced by burning fuel was consumed by various electrical loads, rather than by propelling the vehicle. Batteries 270 are used to accumulate energy during lower-utilization periods so that the vehicle can continue to function despite transient electrical loads that might exceed the alternator's peak output rating.

As is well-known in the art, alternator 250 can be controlled to produce more or less electrical power (while imposing a proportionally larger or smaller mechanical load on ICE 200). The alternator/charging-control system 260 typically targets an alternator output that is sufficient to maintain a system voltage slightly above the battery voltage, so the batteries will maintain a charge.

An embodiment of the invention is designed to augment, rather than replace, a mass-transit vehicle's existing electrical generation, storage and distribution subsystem. Of course, a clean-sheet hybrid design may offer greater opportunities for improving efficiency, but the cost of replacing older vehicles is often prohibitive, whereas an add-on system can be installed less expensively, and the efficiency improvements it offers may provide a compelling overall value proposition.

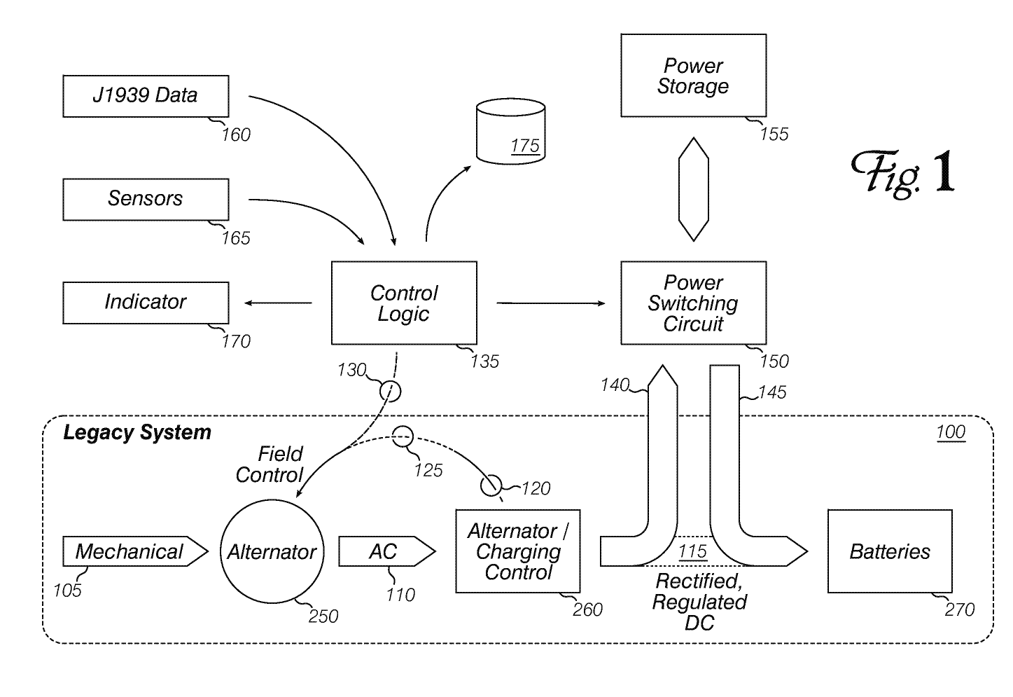

FIG. 1 shows the legacy alternator 250, alternator-controller 260 and battery 270 systems of FIG. 2 in greater detail (100 generally), and the small number of connections needed to add an embodiment of the invention. As previously described, the legacy electrical generation and storage system receives mechanical power 105 and converts it to alternating-current (“AC”) electrical power 110 in alternator 250. This AC power is normally rectified and voltage regulated by alternator/charging control (also called a regulator/rectifier) 260, then provided to batteries 270 through connection 115. Alternator control 260 adjusts the amount of mechanical power 105 that is converted to electrical power 110 by changing the energization of alternator 250's field coil via connection 120.

An embodiment of the invention ties into the legacy system at three principal points. First, field-control connection 120 is broken (see dashed line 125), and field control 130 is provided by control logic 135. Second, regulated/rectified DC connection 115 is broken and redirected to power switching circuit 150 through connection 140, and back to batteries 270 through connection 145. An embodiment also comprises a power storage module 155, which may be an auxiliary battery (using inexpensive lead-acid cells or higher-performance lithium-ion cells, for example), a capacitor- or supercapacitor-based store, or some equivalent structure.

Control logic 135 may obtain information to govern its operation from legacy sensors or sources such as a P939 data bus 160, or from sensors 165 provided with or integrated into the embodiment. Control logic 135 may also provide an indicator 170 to communicate its status and operation to the vehicle's driver, and/or may store information about its functioning in a mass-storage device 175 (e.g., a hard disk or non-volatile memory system).

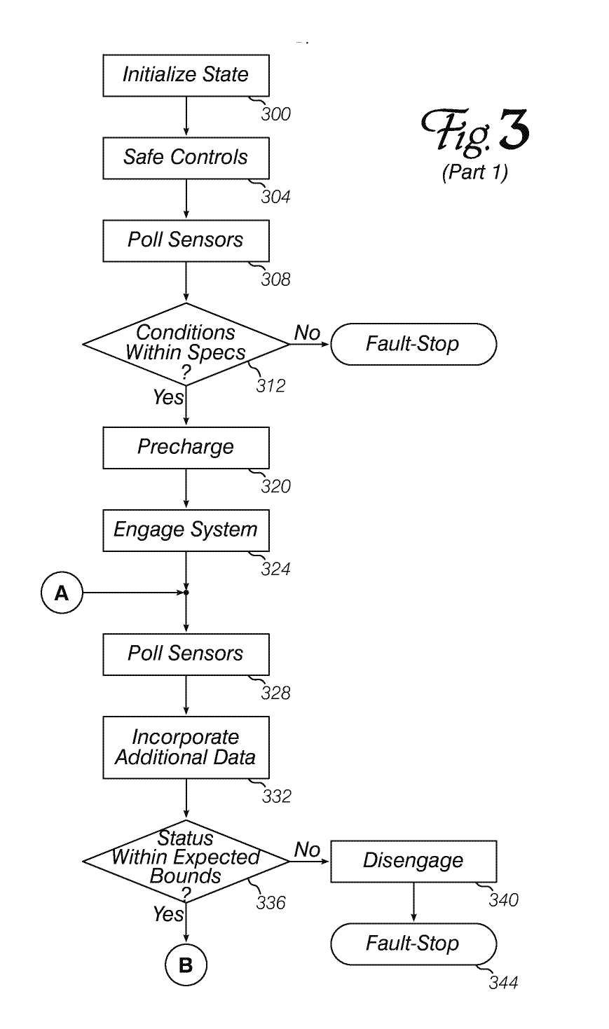

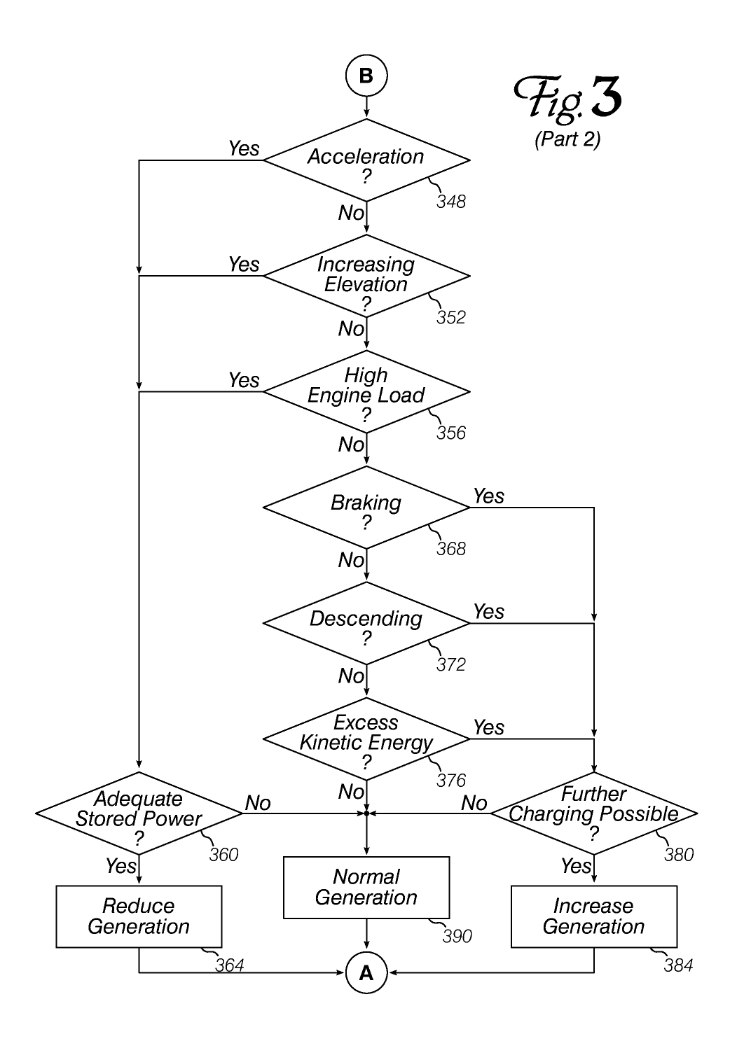

The connections shown in FIG. 1 permit an embodiment to control the rate of conversion of mechanical to electrical energy in the vehicle, and to control the source and destination of generated and/or stored energy through power switching circuit 150. This control is used as outlined in FIG. 3 to improve overall system efficiency by moving some of the load imposed by electricity generation to different times during vehicle operation. Note that the small number of connections permits both simple and modestly-invasive installation, and quick, automatic reconfiguration to the original system arrangement in the event of a fault condition. It is appreciated that the legacy alternator/charging control device 260 is located in a suitable position so that an embodiment could replace the regulator/rectifier, rather than partially bypassing it, as shown in FIG. 1.

The control logic of an embodiment operates as discussed with reference to FIG. 3. The general goal is to relieve the load of electricity generation from the internal combustion engine when the engine's power is needed for acceleration or hill-climbing, and to increase the amount of electricity generated during periods of slowing or incline-descending when the vehicle's excess kinetic energy would normally be converted to heat in the transmission or brakes. (Instead of viewing operations of an embodiment as increasing or decreasing the amount of electricity generated, one can consider the operations as increasing or decreasing the mechanical load placed on the engine by the alternator, with the goal of turning undesired or excess kinetic energy into “free” electricity—that is, electricity that does not require the burning of fossil fuel to produce.) The power-storage capability of an embodiment permits greater flexibility in deferring generation by allowing the batteries or capacitors to supplement the legacy batteries' current-sourcing capability, and by absorbing and storing extra energy generated during braking or deceleration that could not be used to charge the legacy batteries without damaging them.

Upon system initialization (e.g., when the vehicle is turned on), the control logic of an embodiment initializes its own state (300) and places all switches, connections and controls in a safe state (304). In some embodiments, a contactor (i.e., high-current-capacity switch) in the power-switching circuit may be set so that the embodiment is effectively disconnected from the legacy system and does not affect its operation. Sensors are polled (308) and, if system conditions are within expected limits (312), a pre-charge cycle may be performed (320) to match contactor input and output voltages, then the contactor is engaged (324).

Now, sensors are polled (328) and any data being transmitted over the vehicle's communication bus are incorporated into the control logic's system model (332). If any sensor indicates an unexpected, harmful or dangerous condition (336), then the embodiment is disengaged (340) and a fault indication may be given (344).

Otherwise, if a sensor detects acceleration (348), increasing elevation (352) or another high-engine-load situation (356) and adequate energy to meet current vehicle electric demands is in the legacy batteries and/or the power storage subsystem (360), alternator energy conversion is reduced (364) (e.g., by weakening the field control signal). If a sensor detects braking (368), engine braking (hill descending) (372) or another kinetic-energy-reducing situation (376) and the legacy batteries and/or the power storage subsystem can accept additional charge (380), then alternator energy conversion is increased (384) (e.g., by strengthening the field control signal). Otherwise, the field control signal is set appropriately to cause the alternator to generate electricity adequate to meet the vehicle's present needs (including maintaining legacy battery stage of charge) (390). This process repeats while the vehicle is in operation and no fault condition has been detected.

It is appreciated that an embodiment can achieve additional fuel savings by adjusting the “normal generation” target (390) to reduce alternator generation when the batteries (and any other electricity storage devices such as capacitors) are full. When the batteries are full, they cannot accept additional charge without damage, so the system cannot take advantage of excess kinetic energy that becomes available. For this reason, it may be desirable to use some of the batteries' stored energy to “free up” capacity for future charging. Thus, even under “normal generation” circumstances, an embodiment may reduce the amount of electricity that the legacy system would otherwise attempt to produce.

Another specific situation where an embodiment's activities can be observed is while the vehicle is either coasting (neither accelerating nor slowing, and not requiring much input power from the ICE to maintain the desired speed), or completely stopped. In these cases, the engine is at or near idle, and the mechanical load is very low. An embodiment may reduce electricity generation and permit some depletion of the batteries' stored reserves, to avoid causing the engine to operate in an inefficient, modest-power-output range, solely to provide for the vehicle's instantaneous electric demand. Of course, the embodiment will monitor the batteries' state of charge, and if it falls below a configurable level, electrical generation will have to be resumed to avoid excessive battery discharge.

The control logic of an embodiment may make use of a wide range of types of sensor data to improve its operation. As mentioned above, an accelerometer may indicate whether the vehicle is speeding up (and/or traveling uphill), or slowing down (traveling downhill). Individual-cell and aggregate battery pack voltage monitors may be used to estimate the state of charge of the pack or to detect charging imbalances. Current sensor readings can be integrated to provide an estimate of the watt-hours available from the legacy battery pack and/or the power storage subsystem, as well as the instantaneous and averaged vehicle electrical demand. Temperature sensors that monitor the battery pack(s) can help prevent overcharging. Throttle and brake position may be monitored by add-on sensors, or may be obtained from reporting over the vehicle's drive-by-wire communication bus. Gross vehicle weight may be sensed directly or estimated from accelerometer and throttle or engine-output data, and this information may be used to adjust how aggressively the system works to convert excess kinetic energy to electrical energy during deceleration.

It is appreciated that the system's extra energy extraction may be perceived by drivers as a stronger-than-normal engine-braking effect. In tests, drivers have proven easily able to adjust their vehicle operation to account for this effect.

In some embodiments, the control logic may produce a “power recovered” indication (e.g., an analog meter or bar graph) to help drivers get the most out of the system. Other embodiments may display a numeric estimate of miles-per-gallon (or other similar efficiency metric). This information can be stored for later review by transit authority operators or auditors, and used to reward drivers who are able to use the system to achieve fuel savings in excess of the average savings provided by the invention.

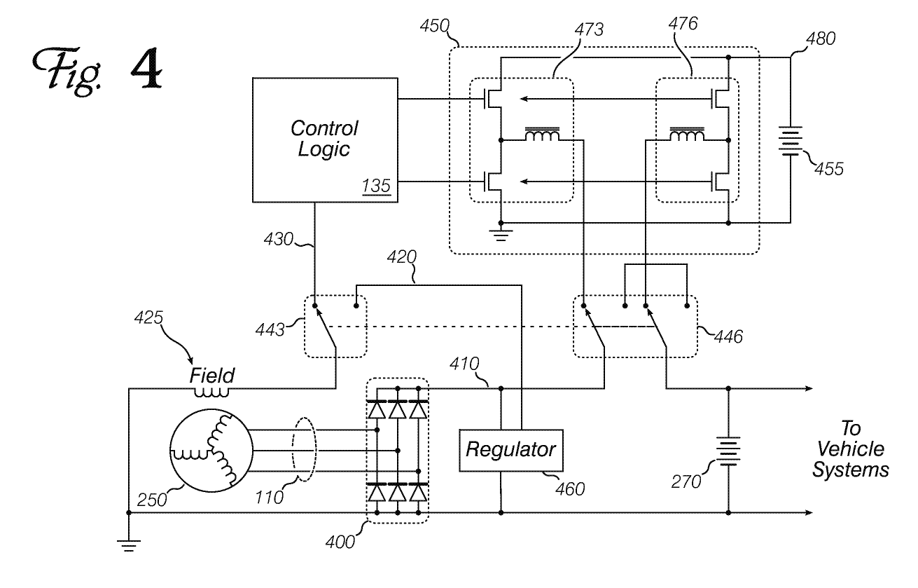

FIG. 4 is a high-level schematic of an embodiment of the invention, showing details of some of the circuits and subsystems that were first discussed with reference to the block diagram of FIG. 1. These circuits are also simplified: support circuitry and structures necessary to compensate for the non-ideal characteristics of actual electronic components have been omitted to avoid obscuring the principal functional elements.

As previously described, electrical power generation for the vehicle begins with alternator 250. This produces AC power 110, which is rectified by diodes 400 to produce DC power 410. Regulator 460 is the vehicle's own charging control circuit; before the system is augmented with an embodiment of the invention, its output 420 drives the field coil 425 of the alternator according to a control/feedback loop to provide adequate power for the vehicle's batteries 270 and other electrical systems.

Switches 443 and 446 indicate points at which an embodiment can be integrated with the vehicle's existing systems. The switches are shown in the “embodiment engaged” position; if they are switched to the other position, then the vehicle operates as if the embodiment had not been installed.

Circuit 450 is the power switching circuit shown as element 150 of FIG. 1, and battery 455 serves as power storage 155. Control logic 435 controls power switching circuit 450 and provides field control signal 430. (Sensor inputs and other connections of control logic 435 are not shown in this figure.)

In operation, control logic 435 causes alternator 250 to produce, and power switching circuit 450 to distribute, electrical power as outlined in the flow chart of FIG. 3. Each of the MOSFET+inductor subcircuits 473, 476 is a bidirectional power transfer controller. For example, 473 draws current from alternator 250/rectifier 400 and supplies it to circuit node 480 where it can charge battery 455 and/or be transferred through 476 to charge the normal vehicle battery 270 and to supply the vehicle's other electrical needs.

Switches 443 and 446 may be implemented as mechanical relays, controlled by control logic 435. DPDT switch 446 should be sized to handle significant currents (at least as large as the largest possible vehicle load plus charging currents). Use of latching relays or contactors may help improve operational efficiency, at a cost of slightly increased control software complexity.

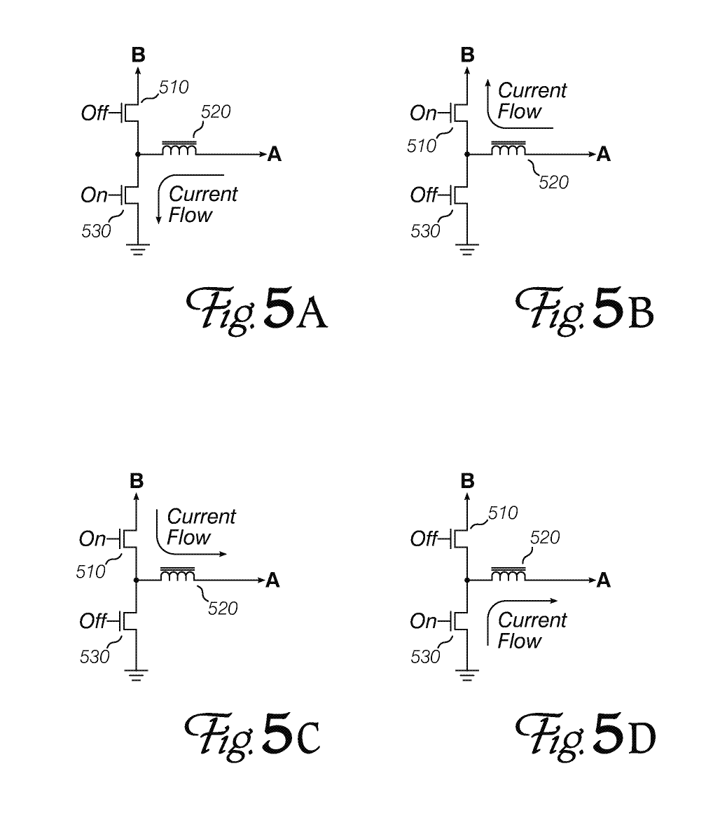

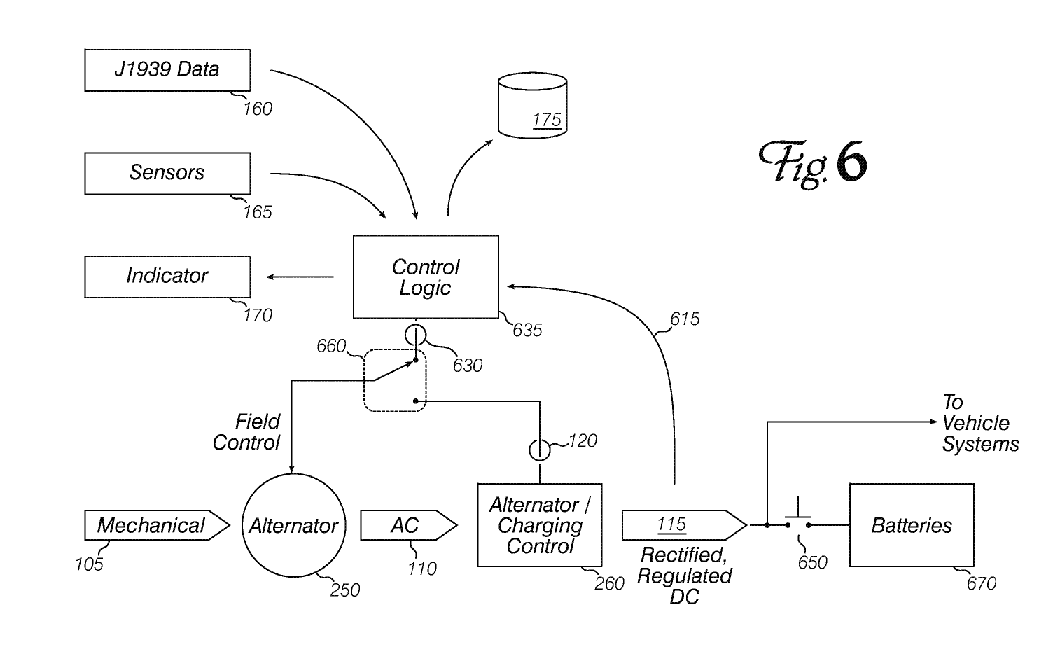

FIGS. 5A through 5D show how a subcircuit such as 473 or 476 can operate as a bidirectional power transfer controller. In this example, circuit point A is at a lower potential (relative to ground) than point B. To transfer power from A to B, FET 530 is turned on to permit current to flow from A through inductor 520, charging the inductor's magnetic field (FIG. 5A). Next, FET 530 is turned off and FET 510 is turned on. As the magnetic field collapses, current is forced through FET 510 and into B (FIG. 5B).

To transfer power (or permit power to flow) from B to A, FET 510 is turned on, allowing current to flow from the higher potential node B, through inductor 520, to A (FIG. 5C). Inductor 520 prevents the instantaneous dumping of energy from B to A; instead, the current builds gradually according to the source and destination impedances and the inductance, and energy is stored in the inductor's magnetic field. Finally, FET 510 is turned off and FET 530 is turned on, allowing current to continue to flow through inductor 520 as the magnetic field collapses (FIG. 5D). Similar circuits can be used to transfer energy from points whose potentials (relative to ground) are reversed, or are at the same potential.

An embodiment such as that depicted in FIG. 4 may provide the greatest flexibility in accomplishing the invention's goal of moving some electricity-generation work away from periods of peak engine load and toward periods of kinetic energy recovery, but the power switching circuit 450 is called upon to control significant amounts of current. This may complicate the design of the circuit and/or increase its cost. At least two other embodiments may be able to achieve energy savings according to the method of the invention, at a lower cost or with reduced implementation difficulty.

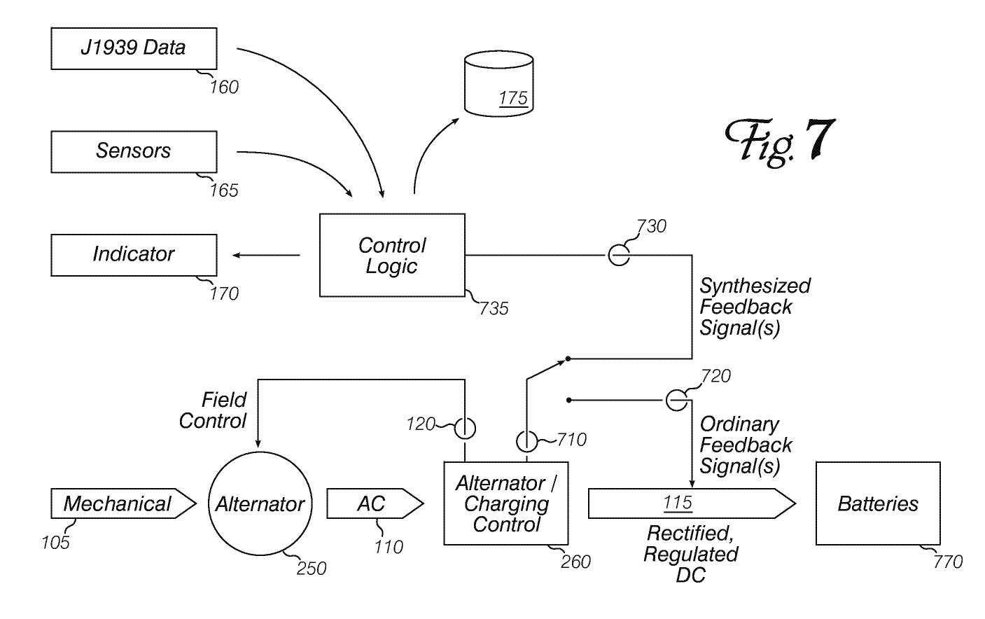

FIG. 6 shows a first alternate embodiment, which omits the power switching circuit and power storage shown in FIGS. 1 and 4. Instead, this embodiment relies on the legacy alternator/charging control circuit 260 to rectify and voltage-regulate the output of alternator 250, and simply takes over control of the alternator field coil via connection 630. Control logic 635 may receive additional sense data 615 from the vehicle's electrical bus (for example, bus voltage and charging/operating current) so that it can avoid overburdening the vehicle's regulator/rectifier and overcharging or excessively discharging the batteries. In this embodiment, the vehicle's legacy batteries (which are often lead-acid batteries of modest capacity and performance) may be replaced by higher-performance lithium-based (“lithium chemistry”) batteries 670. These batteries may permit higher charging and discharging currents, and their terminal voltage may fluctuate less than the legacy batteries. However, even without replacing the batteries, an embodiment can realize efficiency gains by moving electricity generation loads to different times during vehicle operation. In this embodiment, a contactor or switch 650 may be provided to disconnect the batteries completely for service or upon detection of a fault condition. Furthermore, a switch 660 may restore the legacy alternator/charging control unit's control of the alternator field. With switch 650 disconnected and switch 660 in the other position from its depiction in FIG. 6, the vehicle will operate as if the battery had simply failed (e.g., via a main-fuse disconnect) and/or been removed, and all the vehicle's electrical loads are supplied directly from the alternator and regulator.

FIG. 7 shows a second alternate embodiment. Like the embodiment of FIG. 6, this embodiment lacks a power switching circuit and independent power storage. This version of the invention affects electricity generation by synthesizing a feedback signal 730 to alter the legacy alternator/charging-control circuitry's operation. The signal must be designed with knowledge of the legacy system's control loop. For example, if the legacy system uses a simple output-voltage targeting loop, then control logic 735 can force increased electricity generation by synthesizing a “low voltage” feedback signal to replace or override the ordinary feedback signal 720, and force decreased electricity generation by synthesizing a “high voltage” feedback signal. In effect, the synthesized feedback signal “fools” or “tricks” the legacy system into changing its normal electricity generating target.

This embodiment may suffer from instability, oscillation or otherwise poor performance if the underlying (legacy) feedback loop is attempting to target a dynamic or incompletely-understood state space. For example, if the vehicle's own system is designed to perform constant-current/constant-voltage battery charging (i.e., constant charging current until a first state-of-charge target is reached, then constant charging voltage until a second state-of-charge target), then the embodiment may have difficulty simulating the appropriate sensor inputs to cause the legacy charging system to function as desired to save fuel. However, when this method can be used, it may require less-expensive hardware to implement. Note that this embodiment may also benefit from the replacement of a legacy lead-acid battery pack with a higher-performance pack 770 such as a lithium-polymer or lithium-ion battery pack.

Any embodiment of the invention may include individually-fused battery voltage sense lines, cell balancers to keep each cell in the pack charged equally, or contactor pre-chargers to reduce arcing when switches are opened or closed. Lower-cost, modest performance embodiments may not provide any additional sensors (such as accelerometers and battery temperature gauges), relying instead on whatever sensor information is available from the legacy system. At the other extreme, an embodiment may use global positioning system (“GPS”) data, route maps, realtime traffic data, and other information to predict future electrical loads and “free” electricity-generation opportunities. Thus, for example, if it is known that a long hill descent is coming up, present electrical generation may be deferred and the batteries may be allowed to discharge to a very low level so that they will be able to accept more of the energy that will be available during the descent.

Many embodiments of the invention are intended to be installed as retrofit solutions on existing vehicles. The installation process typically involves maintenance, modification or even replacement of the vehicle's batteries. It is appreciated that this process offers an opportunity to make additional changes to the battery and electrical system to obtain further efficiency or performance improvements. In particular, it is understood that batteries perform less well, and may even be damaged, by operation at particularly low or high temperatures. To prevent this, an embodiment may include sensors to measure battery temperature and physical or operational features designed to adjust battery temperature. For example, an embodiment for use in warm climates may include refrigerant condensers that can be plumbed into the vehicle's existing cooling or environmental-control systems to cool the batteries (or, as a simple, low-tech solution, cool air from the vehicle's interior can be blown into the battery enclosure with a fan). In cold climates, resistive electrical heaters can help keep batteries warm. Alternatively, simply operating other portions of an embodiment in an inefficient manner (e.g., switching at a higher frequency than required) may produce enough heat to begin to warm the batteries. (It is appreciated that batteries will normally self-heat during charging and discharging, so the additional resistive heaters or heat-producing inefficient operation may only be needed during initial start-up/warm-up operations.)

The applications of the present invention have been described largely by reference to specific examples and in terms of particular allocations of functionality to certain hardware and/or software components. However, those of skill in the art will recognize that vehicle charge rate control can also be produced by software and hardware that distribute the functions of embodiments of this invention differently than herein described. Such variations and implementations are understood to be captured according to the following claims.

I claim:

1. A control system to partially bypass a regulator/rectifier of an internal-combustion vehicle, comprising:
means for altering a normal rate of conversion of mechanical to electrical energy in the vehicle; and
control logic to increase the rate of conversion in a first situation and to decrease the rate of conversion in a second situation.

2. The control system of claim 1 wherein the means for altering the normal rate of conversion comprises a control signal to drive a field coil of the vehicle's alternator.

3. The control system of claim 1 wherein the means for altering the normal rate of conversion comprises a simulated feedback signal to cause the regulator/rectifier to alter its normal electricity-generation target.

4. The control system of claim 1 wherein the first situation occurs when the vehicle is slowing and a battery of the vehicle can accept additional charge without damage; and
the second situation occurs when the vehicle is accelerating and the battery of the vehicle can supply electrical loads of the vehicle despite decreased conversion of mechanical energy to electrical energy.

5. The control system of claim 1, further comprising:
a lithium-ion battery pack to be charged by electrical energy converted from mechanical energy in the vehicle.

6. The control system of claim 1, further comprising:
a power switching circuit to transfer electrical power between the vehicle's alternator, a battery pack of the vehicle, and an auxiliary battery pack.

7. The control system of claim 1, further comprising:
an accelerometer, wherein
the first situation occurs when the accelerometer indicates that the vehicle is slowing; and
the second situation occurs when the accelerometer indicates that the vehicle is accelerating.

8. The control system of claim 1, further comprising:
means for receiving vehicle information from a drive-by-wire data bus of the vehicle.

9. The control system of claim 1, further comprising:
a switch to disengage the control system and restore normal operation of the regulator/rectifier.

10. A charging control system to replace a voltage regulator in an internal-combustion vehicle, comprising:
a sensor to sense a condition on the vehicle; and
control logic to set a rate of charging of batteries in the vehicle according to data from the sensor, wherein
the rate of charging is increased when the sensor indicates that the vehicle is slowing or descending without accelerating; and
the rate of charging is decreased when the sensor indicates that the vehicle is accelerating or ascending.

11. The charging control system of claim 10, further comprising:
a J1939 interface to receive data from a drive-by-wire data bus of the vehicle, wherein
the control logic is to adjust the rate of charging according to data from the J1939 interface.

12. The charging control system of claim 10, further comprising at least one of:
a condenser unit to cool the batteries;
a fan to blow air-conditioned air from the interior of the vehicle into an enclosure of the batteries; or
a resistive heater to warm the batteries.

13. The charging control system of claim 10, further comprising:
a data storage device to record data received by the control logic and the rate of charging set by the control logic.

14. A system for improving fuel efficiency of a mass-transit vehicle, comprising:
a lithium-chemistry battery pack to replace a lead-acid battery pack of the vehicle;
a control unit to receive information from at least one legacy sensor of the vehicle and at least one add-on sensor of the system; and
an indicator to be installed within a field of view of an operator of the vehicle, wherein
the control unit is to increase a rate of conversion of mechanical energy to electrical energy by increasing a current supplied to a field coil of an alternator of the vehicle when the control unit receives information that the vehicle is slowing clown;
the control unit is to decrease the rate of conversion by decreasing the current supplied to the field coil of the alternator when the control unit receives information that the vehicle is accelerating; and
the control unit is to display an estimated fuel savings on the indicator.

15. The system of claim 14 wherein the control unit is to receive information from the at least one legacy sensor via a drive-by-wire data bus.

16. The system of claim 15 wherein the drive-by-wire data bus is a J1939 data bus.

17. The system of claim 14 wherein the at least one add-on sensor is an accelerometer.

18. The system of claim 14, further comprising:
a contactor to disconnect the lithium chemistry battery pack.

19. The system of claim 14, further comprising:
a switch to disconnect the control unit from the field coil of the alternator.

20. The system of claim 14, further comprising:
a data storage device to record readings from the at least one legacy sensor and the at least one add-on sensor.
